(19) United States
(12) Patent Application Publication
(10) Pub. No.: US 2006/0042458 A1
(43) Pub. Date: Mar. 2, 2006

(54) Device applied in electronic connectors of energy provided with unit of detonation incorporated in a button for detonation of cartridge with powder

(75) Inventor: Joao Augusto Freire Vieira, Valinhos (BR)

Correspondence Address: NORRIS, MCLAUGHLIN & MARCUS, 875 THIRD AVE, 18TH FLOOR, NEW YORK, NY, 10022, US

(73) Assignee: KRJ Industria E Comercio Ltda., Sao Paulo (BR)

(21) Appl. No.: 10/932,933

(22) Filed: Sep. 2, 2004

(51) Int. Cl. B64D 1/04

(52) U.S. Cl. 89/1.14

(57) ABSTRACT

A device applied to electric connectors of energy provided with unit of detonation incorporated in a button for detonation of cartridge with powder comprising a device for the installation of pressure electrical connectors on two electrical conductors, the tool has three main components the first is called power unit with a piston, the second is the power unit (2) and the third is a cartridge carrier, the power unit (2) and the shooting unit (9) being coupled through a thread (8) that holds them firmly together, therefore forming only one set, on its interior is the cartridge carrier (14) and the metallic cartridge (12) with gunpowder, properly placed, the shooting unit (9) has on its interior a compound system by pins and springs linked to a shooting button (34) that will cause the detonation of the cartridge (12) with gunpowder by the impact of a detonation needle (57) on this cartridge (12), also a piston (11) on the interior of the power unit (2) will be impelled against one of the components of the electrical connector to be set, therefore obtaining the intended electrical connection.

### BACKGROUND OF THE INVENTION

1. Field of the Invention

The present invention relates to an electrical connection device with a shooting button and accessories that comprises a device used for the appliance of electric connector in nets of distribution and transmission or the power system. This connectors provide a link between two electric conductors named trunk and electric shunt. Both, the trunk and the electric shunt, are firmly pressed against each other through the action of two different components that are set through the device that is the subject of the present invention. The present invention uses metallic cartridges with gunpowder in order to generate the energy needed to for the appliance. The cartridges are detonated by the simple act of pressing a button.

2. Description of the Related Art

Devices used for this kind of appliance are known in the art, see, for example, U.S. Pat. No. 4,722,189, BR PI 9303375-3 and BR PI 0106296-4. The first two references refer to devices that also use plastic and metallic gunpowder cartridge. In those devices the detonation is made through the use of a hammer by the user, when the hammer crashes with the back part of the device it will start the detonation of the cartridges mentioned above. The latter device listed above uses a metallic cartridge with a trigger detonation system that happens after the hand coupling by the user of the two units, after the coupling the user also has to push the trigger that will generate the detonation of the cartridge with the gunpowder.

### SUMMARY OF THE INVENTION

The present invention relates to a product that gathers the advantages of the former techniques when it eliminates the interference of the user on the final result of the appliance, it's also ergometrically more favorable, its liability and productiveness are bigger, it is safer and of easy and quick handling and it has the proper power for the achievement of the objective sought. All this is accomplished through a simple push on a button connected to a pin and spring system that will start the action of a detonation needle on the metallic cartridge with gunpowder.

The invention is basically made by three main components, the first one is denominated as power unit with piston, the second one is denominated as shooting unit, and the last one as cartridge carrier, they are all firmly set with the placement of this cartridge carrier that is set with a 22 caliber metallic cartridge into the power unit. The shooting unit is threaded on the first set, therefore, forming only one set, firmly bonded, now this only set is coupled to a auxiliary head on which the connector and the conductors to be linked will be adjusted. At the threading of the shooting unit on the power unit there's a spring of detonation that is loaded inside the shooting unit, the spring is already fitted into a pin of detonation that is now in conditions of being impelled by this spring, but that doesn't happen because there's a predominant cylindrical piece supported, in it's lower part, on a second spring, blocking it.

The cylindrical piece that forms, on its upper part, the shooting button of the tool has a window passage which was made in order to allow the entrance of the detonation pin described, but only when the movement of pushing the shooting button is made. The dislocation of the shooting button extinguishes the blocking of the detonation pin that is impelled by the detonation spring, previously loaded, then it enters the window in great velocity and crashes itself against the posterior front of a detonation needle, which is also on the shooting unit. This crash will generate a small movement by the detonation needle, although enough to touch the back part of the metallic cartridge in the place where the chemical elements that will generate the detonation are lodged. The user of the tool can only use the shooting button after the lifting of a small protective and safety lid. After the detonation the user does a reverse operation unthreading the shooting unit of the power unit. The shooting unit goes back to the original position after removal. Then, the user takes of the cartridge carrier of the power unit and does a removal operation of the detonated metallic cartridge through a cleaning rod attached to the protective and safety lid, or using a loose cleaning device for the cartridge carrier.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several views:

FIG. 1: Illustrates an overall view of the device.

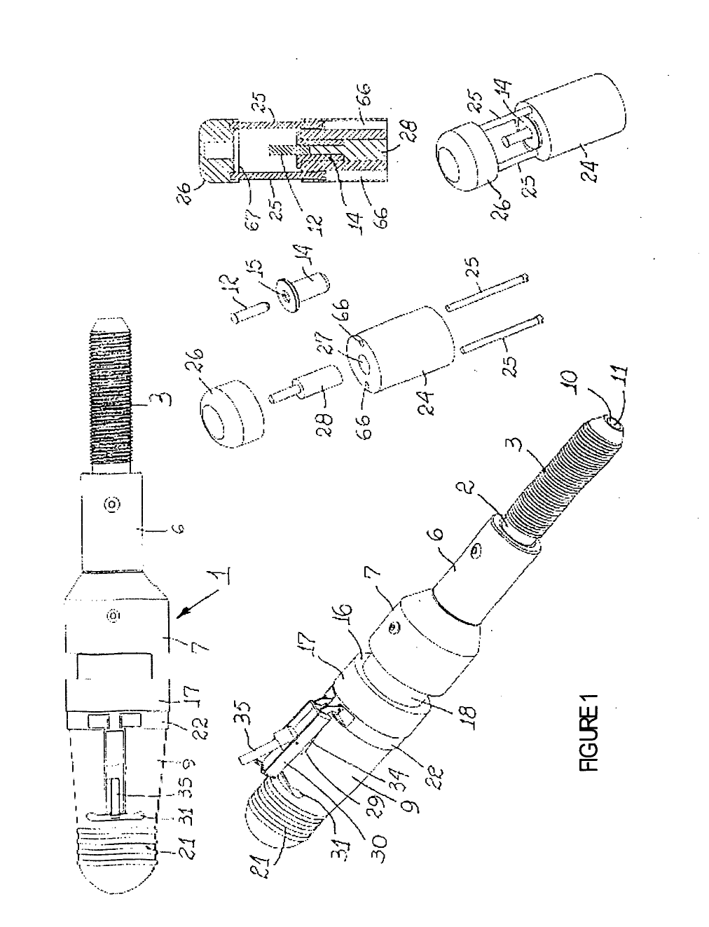

FIG. 2: Illustrates the components of the power and shooting units.

FIG. 3: Illustrates a view of a slitting cut of the device, showing the several components that are part of it.

FIG. 4: Illustrates a view of the overall device set with the electric connector and cables.

### DETAILED DESCRIPTION OF THE PRESENTLY PREFERRED EMBODIMENTS

As seen in the figures, the device (1) of the present invention, has a metallic piece predominantly cylindrical (2) power unit, which has on its end a thread (3) that is used for coupling with the auxiliary head (4) on the appliances operations of a electric connector (5). The power unit (2) has a smaller glove (6) and a bigger glove (7) in order to serve as a handle to make the turning operation of the power unit easier when the coupling of the auxiliary head (4). In its posterior part, the power unit (2) has a thread (8) that will be used for the coupling of the shooting unit (9). The power unit (2) has, along with it's slitting cut, a by-pass hole (10) that holds the piston (11) comprising of three diameters along its axle. During the process of the metallic cartridge (12) detonation it is pushed by the power of the explosion and expansion of the gases, allowing the effective link of the connector (5) and its respective electric conductors (13). The detonation described above is only possible because the cartridge carrier (14) is only one piece but it has two different diameters with a by-pass opening (15) that allows the introduction of the metallic cartridge (14) on its inside. The set of the cartridge carrier (14) and the metallic cartridge (12) set are fitted in the power unit (2) by its posterior part, in its by-pass hole (10), and are involved by the shooting unit (9) that when threaded on the power unit (2), through the thread (8), holds the entire set, which consists on the shooting unit (9), cartridge carrier (14) and metallic cartridge (12), power unit (2) and respective piston (11), in a only and firmly unified set. The shooting unit, in turn, has on its front a double front nut (16) which is made of to parts, with the same center (17)/(18) but two diameters, and of two internal threads (19)/(20), therefore being the connection link between the power unit (2) and the shooting unit (( ). On the back of the shooting unit (9) there's a protection rubber (21) against damage from downfall and beats on the metallic cover or main polymeric (22).

The cleaning of the cartridge carrier (14) can be done by the cleaning device consisting of a cylindrical body (24), two guide rods (25) and one cover (26). On the cylindrical body (24) there's a opening (27) for the cleaning pin (28) which will do the cleaning of the cartridge carrier (14). On the external part of the main cover (22) there's a passage window (29) that is covered with a tilter lid (30) that is locked at the fitting (31) of the lock (32) and is tilter because of the lid pin (33). The main cover (22) has a metallic or polymeric piece consisting of a shooting button (34) that has a final part standing out from the main cover (22), therefore it can be subjected to a outside action as a press or action of pushing on the transverse direction of the tool's axle by one of the fingers, that will start the de detonation of the metallic cartridge (12). The lid (30) has on it a cleaning metallic rod (35) that tilters by the pin (36), its purpose is to clean the cartridge carrier after the detonation of the metallic cartridge (12).

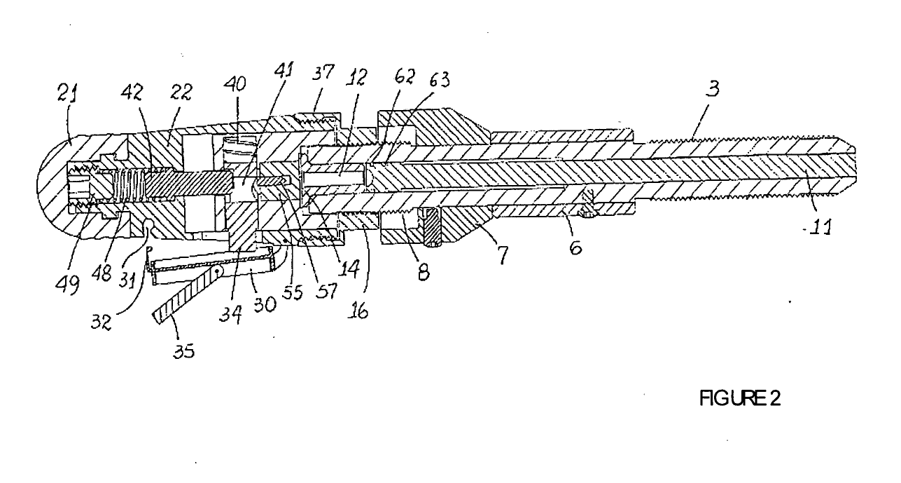

FIG. 2 shows the present invention taken apart with all its components. So, the shooting unit (9) consists of nut front (16) with two different diameters (17)/(18), internal threads (19)/(20) for the coupling on the power unit (2) through the thread (8) in it. The main cover (2) has a thread (37) on its front for the coupling with the front nut (16), and another on the passage window (29), through which the shooting button (34) stands out, it also has a fitting (31) in order to lock the security lid (30) when it is closed. On the inside of the main cover (22) there is the detonation system of the metallic cartridge (12), it consists of a piece on the shape of a barrel (38) that has the first opening (39), through this opening goes the spring of the shooting button (40) and the actual shooting button (34), in its turn the shooting button has a window (41) for the passage of the detonation pin (42); through the second opening (43) goes the guide pin (44) and the spring (45) of the guide pin which, through the side conduit (46) allows the movement of return of the barrel (38) after the metallic cartridge (12) detonation; on the third opening (47) goes the detonation pin (42) impelled by the detonation spring (48) that is settled by the lid with the thread (49) that in turn is threaded on the salience (50) at the posterior part of the main cover (22); the forth opening with thread (51) on the barrel allows a lock-needle (52) to go in, made by a small cylindrical piece with a thread (53); the fifth opening of the barrel is where the needle carrier (55) is fitted, it consists on a small solid cylinder. The needle carrier (55) has a opening (56) where the detonation needle (57) is settled, it is locked by the lock-needle (52) at the opening (58). In turn the power unit (2) consists of a cylindrical body (59) with a front thread (3) of head (4) coupling and another posterior thread (8) for the coupling with the nut (16). The body (59) has a by-pass hole that allows the passage of the piston (11) which has on its posterior part a sealing main metallic elastic ring (62) of the gases and for the retention of the piston (11), it also has another secondary metallic elastic ring (63) with the same purpose. The by-pass hole also allows the cartridge carrier (14) introduction, the cartridge carrier (14) that has a by-pass opening (15) through which the introduction of the metallic cartridge (12) happens. On the body (59), through screws, the smaller glove (6) and the bigger glove (7) are attached; they work as glove iron to easy the handling of the power unit (2).

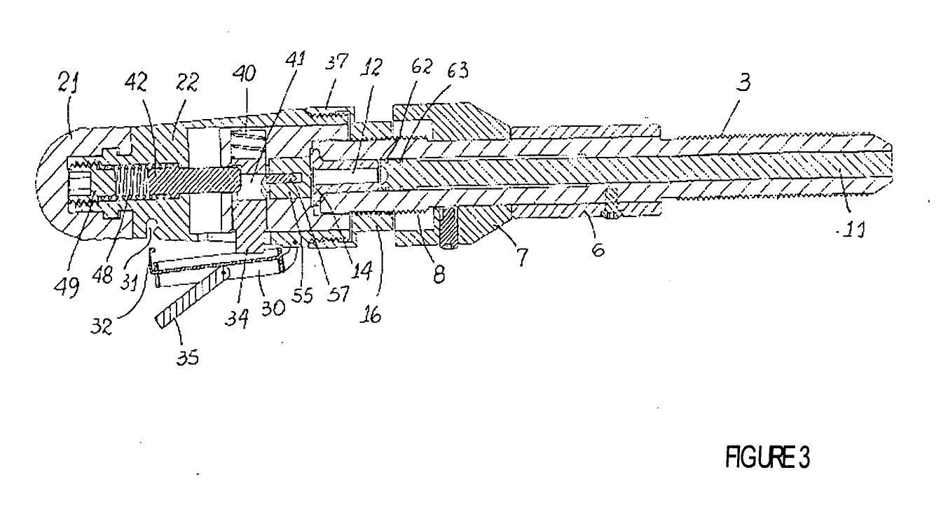

FIG. 3 of the present invention shows a the device cut,and it represents the device in a intermediate position during the threading of the shooting unit (9), on this figure it's possible to notice all the components previously described on this intermediate position.

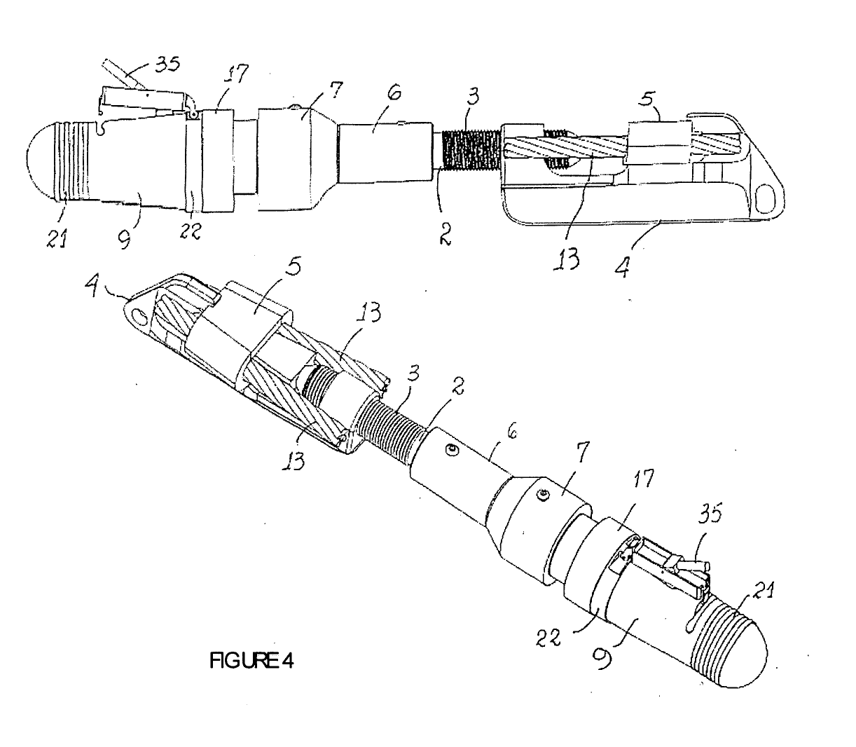

FIG. 4 shows the device set with the auxiliary head (4), the electrical connector (5) and their own electrical conductors (13) on the shooting and appliance position of the electrical connector (5).

In summery, the appliance of the present invention and how it works, the following steps can be described:

The user couples the power unit (2) on the auxiliary head (4) where the electrical connector and its respective electrical conductor are already lodged;

Immediately after the cartridge carrier (14) has to be prepared, the metallic cartridge (12) is set on the by-pass opening (15) of the cartridge carrier (14) and, in turn, the cartridge carrier (14) is set on the by-pass hole (10) of the posterior part of the cylindrical body (59) of the power unit (2).

Then it is necessary to thread the shooting unit (9) through a thread (8) and a nut (16) on the power unit (2). During this procedure, the detonation spring (48) is loaded because the barrel (38) moves freely inside the main cover (22), in turn, the barrel (38) is guided by the guide pin (44) and the guide spring (45), therefore it pushes the detonation pin (42) against the detonation spring (48) loading it. The action of pushing the detonation pin (42) is only possible because it is lined up with the opening (47) on the posterior part of the barrel (38), this opening crosses the opening (39) in a angle of 90° degree leading the detonation pin (42) to met the wall of the shooting button (40) also fitted on the opening (39).

When the threading of the shooting unit (9) on the power unit (2) has finished the tool will be ready to be started and will be on the position showed in FIG. 3, previously described. At this moment the user can push the shooting button (34), which will be available after unlocking and lifting of the security lid (30), the user can push the shooting button (34) on the transverse direction to the symmetrical axle of the tool. At this action, the shooting button (34) will press the spring of the button (40) and will make the window (41) on it line up with the detonation pin (42) which, in turn, is supported by the detonation spring (48) already loaded by the action of the shooting unit (9) threading. Because the window (41) and the detonation pin (42) lined up the detonation pin will be impelled in great speed by the detonation spring (48) against the posterior part of the detonation needle (57) which is already lodged on the needle carrier (55) that, in turn is lodged on the barrel's (38) opening (50). When the detonation pin (42) crashes against the detonation needle (57) the latter will move through the opening (56), enough to heat the metallic cartridge (12) causing it's detonation. At the moment of this detonation the detonation needle (57) will go back on the opposite direction of the detonation gases' movements but it will be impelled by the needle-lock (52), that is threaded in the opening (51) of the barrel (38), and it will go into the opening (58) of the needle carrier (55);

After the detonation, the user will lock the lid tilter (30) and uncouple the shooting unit (9) from the power unit (2), during this movement the guide pin (44) and the guide spring (45) will place the barrel (38) forward at its initial position therefore releasing the detonation pin (57) from the window (41) of the shooting button (34) which will be impelled by the button spring (40) towards a resting position;

After the removal of the shooting unit (9) the user will remove the cartridge carrier (14) with the metallic cartridge (12) already detonated, then the cleaning of the cartridge carrier (14) will take place through the cleaning rod (35) or through the cleaning device which will allow the removal of the metallic cartridge (12) by the introduction of the cartridge carrier (14) on the opening (27), this last procedure will make the opening (15) of the cartridge carrier (14) to fit in the cleaning pin (28). At this position the posterior face of the cartridge carrier (14) where is also the face of the metallic cartridge (12) will be lined up with the lowering (67) on the cover (26), when the cover is pushed and, at the same time, guided bye the two guide rods (25) inside the guide openings (66), it will fit perfectly on the cartridge carrier (14) that will release the detonated metallic cartridge (12) by the pressure of the hands on the cover and the opposite pressure made by the cleaning pin (28). Therefore, the shooting procedures are finished.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

1. A device for an electrical connector of energy with provided with a unit of detonation incorporated in a button for detonation of a cartridge with powder, comprising
a shooting unit (9) including a shooting button (34),
a cartridge carrier for lodging of a metallic cartridge with gun powder,
a power unit including an appliance piston of electrical connectors, wherein the shooting unit (9) has a shooting button (34) and that it is set on the power unit (2) through a quick thread (8), the power unit (2) also has a smaller glove (6) and a bigger glove (7) for handling and a piston (11) for applying an electrical connector (5).

2. The device according to the claim 1, wherein the shooting unit (9) has a frontal nut (16) which comprises a first part (17) and a second part (18), each having different diameters, the first part and the second part include internal threads for coupling with the power unit (2) and the shooting unit (9) respectively.

3. The device according to the claim 1, wherein the piston (11) has three different diameters along its longitudinal axle, and wherein, on its posterior part, there is located the on a bigger diameter of two metallic elastic rings a main ring (62) and a secondary ring (63), for providing sealing the gases and for holding the piston backwards.

4. The device according to claim 1, wherein the power unit (2) has on located posteriorly, a quick nut (8) and, centrally located, a smaller glove (6) and a bigger glove (7) for handling of the device.

5. The device according to the claim 1, wherein a barrel (38) including a shooting button (34) made of metal or polymer, is disposed in an opening (39) of the barrel (38) on a spring button (40).

6. An electrical connector including a shooting button, comprising
a barrel (38) having a first opening (51) and having a thread adapted for receiving a needle-lock (52), and
a cartridge carrier (55) having a second opening (58) for locking a needle (57) against reactions of cartridge (12) detonations.

7. The device according to claim 1, comprising
a main body (22) having a conical shape,
a window passage (29) for the shooting button (34), covered by a tilting lid (30) which is locked through the passage window (29) and the lock (32), and including a cleaning rod (35) for a cartridge's (12).

8. The device according to claim 1, further comprising a tilting lid (30) which is tilted through the pin (33) lodged in the opening of a cover (22).

9. The device according to the claim 1, wherein the cleaning rod (35) which is tilted through the pin (36) is disposed at a tilting lid (30).

10. The device according to claim 1, further comprising
a shooting unit (9) having a detonation pin (42) connected to a detonation spring (48), and
a guide pin (44) connected to a guide spring (45).

11. A device according to the claim 1, comprising a cartridge (12) cleaning device for cleaning after the detonation, the cleaning device having two guide rods (25), a cover (26) capable of lowering (67) of a cartridge carrier (14), a cylindrical body (24) with two opening guides (66) diametrically situated opposite to each other, and a cleaning rod (28).

12. The device according to the claim 11, wherein the two guide rods (25) are threaded on the cover (26), slidable by the two openings on the cylindrical body (24).
